(19) United States
(12) Patent Application Publication
(10) Pub. No.: US 2023/0311208 A1
(43) Pub. Date: Oct. 5, 2023

(54) METHOD FOR ADDITIVE MANUFACTURING OF AT LEAST ONE METALLIC AND/OR CERAMIC COMPONENT, AND MATERIAL COMPOSITION THEREFOR

(71) Applicant: lncus GmbH, Vienna (AT)

(72) Inventors: Gerald MITTERAMSKOGLER, Vienna (AT); György Attila HARAKÁLY, Vienna (AT); Christian VEIGL, Vienna (AT)

(73) Assignee: lncus GmbH, Vienna (AT)

(21) Appl. No.: 18/129,980

(22) Filed: Apr. 3, 2023

(30) Foreign Application Priority Data
Apr. 4, 2022 (EP) 22020149.5

(51) Int. Cl. B22F 10/14; B22F 3/10; B29C 64/165; B28B 1/00; B33Y 10/00; B33Y 70/10; B33Y 40/20

(52) U.S. Cl. CPC B22F 10/14; B22F 3/1021; B29C 64/165; B28B 1/001; B33Y 10/00; B33Y 70/10; B33Y 40/20

(57) ABSTRACT

In a method for additively manufacturing at least one metallic and/or ceramic component, comprising a) additively building up at least one green part in an additive printing device from a material composition comprising particles of metal and/or ceramic and an organic binder, b) debinding the at least one green part, and c) sintering the at least one green part to obtain the component, the particles are provided with at least one barrier layer enveloping them.

### CROSS-REFERENCE TO RELATED APPLICATIONS

The present application claims the priority of European Patent Application No. 22020149.5, filed Apr. 4, 2022, entitled “METHOD FOR ADDITIVE MANUFACTURING OF AT LEAST ONE METALLIC AND/OR CERAMIC COMPONENT, AND MATERIAL COMPOSITION THEREFOR”, which is incorporated by reference in its entirety.

### BACKGROUND OF THE INVENTION

### 1. Field of the Invention

The invention relates to a method for additive manufacturing of at least one metallic and/or ceramic component, comprising:
a) additively building at least one green part in an additive printing device from a material composition comprising particles of metal and/or ceramic and an organic binder,
b) debinding of the at least one green part, and
c) sintering of the at least one green part to obtain the component.

The invention further relates to a material composition for additive, sinter-based manufacturing of metallic and/or ceramic components, comprising an organic binder and ceramic and/or metal particles.

### 2. Description of the Related Art

Numerous processes are known for the additive manufacturing of components made of ceramic, metallic or mixed materials, which have in common that a green part is built up from particles held together by a binder, whereupon the green part is debinded and sintered. A first group of processes is based on a material composition in which the particles are distributed in the binder mass from the beginning and are therefore permanently in direct contact with the binder mass, the material composition being applied or solidified in a location-selective manner to build up the green part. This group of processes includes stereolithography, nanoparticle jetting, fused deposition modeling (FDM) or fused filament fabrication (FFF), metal pellet FDM, mold slurry deposition, and metal selective laser sintering. In a second group of processes, the binder is only brought into contact with the particles during the printing process. This group of processes includes binder jetting and powder metallurgy jetting.

In both cases, the direct contact of the particles with the binder can have negative effects on the process or the component properties. For example, with some metals there is the problem that released metal ions lead to discoloration or to a change in the reactivity of the material composition. Furthermore, it was observed that direct contact between the binder and the metal particles leads to undesirable polymerization reactions, such as gelling of the material composition, presumably due to cationic polymerization. This is reflected in changed printing characteristics and in the properties of the final component.

Furthermore, it has been observed that especially metal particles absorb oxygen, carbon, nitrogen or other elements during debinding between 100-600° C., which changes the material properties after sintering and in many cases leads to an undesirable change in physical properties. For example, the inclusion of carbon or oxygen in titanium alloys alters the mechanical properties and leads to embrittlement of the metal. Furthermore, the electrical conductivity of copper alloys can deteriorate or the optical properties of ceramics can change.

### SUMMARY OF THE INVENTION

The invention therefore aims to overcome the above disadvantages and to optimize a sinter-based 3D printing process with regard to the special requirements of feedstocks containing powders, in particular feedstocks filled with metal and/or ceramic particles.

In order to solve this problem, the invention essentially provides, in a process of the type mentioned at the beginning, that the particles are provided with at least one barrier layer enveloping them. The invention is thus based on the idea of encapsulating the particles individually to reduce their interaction with the environment, in particular with the binder. In particular, the barrier layer is provided in such a way that it completely surrounds and envelops the respective particle and prevents contact between the particles and their environment, in particular the binder.

The particles may be coated with a single barrier layer or with multiple barrier layers of dissimilar nature (organic and/or inorganic).

In the context of the invention, a barrier layer is understood to mean a layer which
at least impedes, in particular substantially prevents, the passage of oxygen, carbon, metal ions and/or water from the particles to the environment and vice versa, and/or
at least impedes, in particular substantially prevents, a chemical reaction between the particles and their environment, in particular the binder, and/or
improves the chemical resistance of the material composition during storage, the printing process and further handling, i.e. the post-processing.

The barrier properties of the barrier layer against oxygen causes protection against oxidation of the particles during storage, printing process and debinding (at temperatures up to 600° C.).

During debinding, the barrier properties of the barrier layer against carbon cause a reduction in the uptake of carbon originating from the binder into the particles, which leads, for example, to altered chemical or physical properties of the sintered component.

The barrier properties of the barrier layer to metal ions causes a reduction in ion transfer from the particles into the surrounding binder, which prevents discoloration of the material composition (for example, a green coloration in the case of copper) and an influence on the reactivity of the material composition.

The barrier properties of the barrier layer against chemical reactions between the particles and the binder reduces any polymerization reaction by chemical reaction (e.g. cationic polymerization) on the surface, especially metal surface. This in turn results in an improvement in the detail accuracy or resolution of the component due to the prevention of overpolymerization.

Another effect of coating the particles is to increase the flowability of the particles, as the barrier layer leads to a rounding of the particle surface.

Finally, the barrier layer facilitates the development of new variants of material composition. The applied barrier layer ensures a constant interaction between the binder and the particles, which is independent of the selected particle material, resulting in a reduction of the development time.

### DETAILED DESCRIPTION

In a preferred embodiment of the invention, the barrier layer comprises or consists of a metal oxide or metal phosphate. Examples of suitable compounds include AlOₓ, CoOₓ ZrOₓ, SiOₓ, TiOₓ, SnOₓ, LiOₓ, ZnOₓ, NbOₓ, HfOₓ, MgOₓ, NiOₓ, SrOₓ, BOₓ, BaOₓ, WOₓ, BiOₓ, CeOₓ, LuOₓ, DyOₓ, ErOₓ, YOₓ, LaOₓ, TiNbₓO_{y}, LiNbₓO_{y}, LiZrₓO_{y}, LiAlOₓ, LiWOₓ, LiAlOₓ, LiYOₓ, MgAlₓO_{y}, CeZrₓO_{y}, AlPₓO_{y}, LiPₓO_{y}, LiPₓO_{y}N_{z}, TiPₓO_{y}, and Sn(PO₄)ₓ.

Preferably, the metal oxide is selected from the group consisting of silicon oxide, aluminum oxide, boron oxide, zirconium oxide, cerium oxide, iron oxide, titanium oxide, chromium oxide, tin oxide, molybdenum oxide, hydrated oxides thereof, hydroxides thereof, and mixtures thereof.

Particularly preferably, the barrier layer consists essentially of aluminum oxide, silicon oxide or titanium oxide, with silicon oxide being preferred. In the context of the present invention, the term “consisting essentially of” is to be understood as meaning that the respective layer consists of at least 90% by weight, in particular at least 95% by weight, of the specified material.

In another preferred embodiment of the invention, the barrier layer comprises, consists of, or consists essentially of a plastic. The plastic may be selected from the group consisting of polycarbonates, polyvinyl chloride, polyethylene terephthalate, polyacrylate, polymethacrylate, polyether, polyester, polyamine, polyamide, polyol, polyurethane, polyphenol formaldehyde, polyolefin and mixtures thereof. Other organic compounds that attach to the metal oxide layer or to the surface of the metal particles include silanes, acid anhydrides and organophosphorus compounds, as well as titanates and borates. The organic compounds can form bonds with the metal oxide layer of the particles. These organic compounds are preferably covalently bonded to the oxide layer of the particles (or to the particle surface in the absence of an oxide layer) via the silane group, the phosphonate group or one of the acid groups. If the organic coatings contain at least one carbon-carbon multiple bond function, it is possible to crosslink the organic coating with the reactive components of the binder.

For a sufficient barrier effect of the barrier layer, it is advantageous if the barrier layer has an average thickness of 1-300 nm.

The coating of the particles with the barrier layer can be carried out using conventional coating processes, especially those known from thin-film technology. For example, the coating can be applied by physical (PVD, e.g. thermal evaporation or sputtering) and chemical vapor deposition (CVD).

The metal particles are preferably present as metal powder with a particle size of 2-40 μm. The ceramic particles are preferably present as ceramic powder with a particle size of 50-3000 nm.

As mentioned above, the material composition from which the green part is additively built includes an organic binder in addition to the coated particles. The binder has the task of holding the particles together in the material composition so that the material composition forms a homogeneous mass within which the particles are distributed. The binder used here is preferably a chemically or physically (e.g. thermally) at least partially solidifiable material that is flowable or plastically deformable for application and is present in the at least partially solidified state after formation of a green part layer or the green part. Suitable materials for the binder include elastomers, duromers, thermoplastics, waxes, and photochemically curable polymers, or mixtures thereof. In the latter case, a preferred embodiment of the invention provides that the binder contains a photoinitiator for photochemically curing the binder. This allows the material composition to be used in a stereolithographic additive manufacturing process.

In addition to the particles and the binder, the material composition may contain the following components:

Possible material classes for the build-up material are polymers, prepolymers or monomers with one or more functional groups, such as epoxides (glycidyl ethers), acrylates, methacrylates, vinyl ethers, allyl ethers, thiols, norbornenes, proteins, and other substances, in particular biological substances, which crosslink or polymerize chemically when irradiated with UV light directly and/or in combination with a photoinitiator.

UV-curable binder components can include conventional photopolymers known to a person skilled in the art that can be polymerized predominantly by free radicals. These components can chemically crosslink or polymerize when irradiated with UV light directly and/or in combination with a photoinitiator. Examples of radically polymerizable components are in particular acrylate- or methacrylate-functional polymers, prepolymers or oligomers, such as polyester (meth)acrylates, polyether (meth)acrylates, amino (meth)acrylates, (meth)acrylate copolymers, polyurethane (meth)acrylates, epoxy resin (meth)acrylates. For materials filled with metal and ceramic particles, higher chemical reactivity of the polymerization reaction is desirable, so functionalized epoxy or urethane (meth)acrylates are mainly used. The binder may still contain additional components such as absorbers, inhibitors, initiators, reactive diluents, plasticizers, solvents and other liquid or solid additives such as nanoparticles. The entire binder is used in the printing material in conventional amounts known to the skilled person, in particular in amounts of up to 50% by weight of the coating compound, preferably up to 5% by weight.

The choice of the appropriate binder depends on the additive manufacturing process to be used to build the green part. Preferred examples of additive manufacturing processes that may be used in the context of the invention include stereolithography, nanoparticle jetting, fused deposition modeling (FDM) or fused filament fabrication (FFF), metal pellet FDM, mold slurry deposition and metal selective laser sintering, binder jetting and powder metallurgy jetting.

In the context of stereolithographic processes, a preferred embodiment provides that the following steps are performed for each green part layer:
applying a layer of the material composition to form a material layer,
location-selectively polymerizing the material layer to obtain a location-selectively polymerized green part layer.

According to a second aspect, the invention relates to a material composition for additive, sinter-based manufacturing of metallic and/or ceramic components, in particular for carrying out a method according to the first aspect of the invention, comprising an organic binder and particles of metal and/or ceramic, the particles being provided with at least one barrier layer enveloping them.

Preferred embodiments of the material composition relate to the material of the barrier layer and the type of binder, and reference is made in this regard to the explanations given above concerning the method according to the invention.

The invention is explained in more detail below with reference to the following embodiments.

The binder consists of a photopolymer; as an exemplary photo-resin formulation (here based on acrylate) a combination of poly(ethylene glycol) methyl ether acrylate (e.g. 40 mass %, CAS 32171-39-4), diurethane dimethacrylate (10%, 72869-86-4), photoinitiator diphenyl(2,4,6-trimethyl-benzoyl)phosphine oxide (e.g. 1% by mass), a paraffin wax (35% by mass CAS 8002-74-2), an absorber Sudan II (CAS 3118-97-6), and various additives known to a skilled person, for example, dispersants and emulsifiers, may be mentioned.

The powder used is a sealed stored Titan64 alloy (ASTM B348) with a specification of −32 μm. The average grain diameter is approx. 20 μm. Using the atomic layer deposition process known to one skilled in the art, a 3 nm thick layer of SiO₂ is deposited on the powder surface. The binder and the powder of coated particles are mixed in a blending system in a ratio of 50/50 by volume. The resulting printing material or feedstock is stored and its chemical stability is checked via the change in viscosity. Feedstock with untreated particles reacts chemically over the period of a week and is then in a gel-like solid state. The feedstock with coated particles shows no reaction and the viscosity of the feedstock remains unchanged. This passivating effect occurs due to the physical separation of the binder from the particle surface due to the coating.

To test the positive effect of the barrier layer during thermal debinding and sintering, the coated powder was investigated by thermogravimetric analysis (TGA). While untreated powder showed an increase in weight of 0.25% at 400° C. for 1 h (probably caused by oxidation of the powder), no weight increase was observed in the coated powder. Thus, an interaction of oxygen in this temperature range can be excluded.

1-17. (canceled)

18. A method for additive manufacturing of at least one of a metallic component and a ceramic component, comprising:
a) additively building at least one green part in an additive printing device from a material composition comprising particles of at least one metal and ceramic and an organic binder;
b) debinding of the at least one green part; and
c) sintering of the at least one green part to obtain the component;
wherein the particles are provided with at least one barrier layer enveloping them.

19. The method according to claim 18, wherein the at least one barrier layer comprises or consists of at least one of metal oxide and a plastic.

20. The method according to claim 19, wherein the metal oxide is selected from the group consisting of silicon oxide, aluminum oxide, boron oxide, zirconium oxide, cerium oxide, iron oxide, titanium oxide, chromium oxide, tin oxide, molybdenum oxide, hydrated oxides thereof, hydroxides thereof, and mixtures thereof.

21. The method according to claim 19, wherein the plastic is selected from the group consisting of polyamides, polycarbonates, polyvinyl chloride, polyethylene terephthalate, and mixtures thereof.

22. The method according to claim 18, wherein the barrier layer has an average thickness of 1-300 nm.

23. The method according to claim 18, wherein a chemically or physically at least partially solidifiable material is used as the binder.

24. The method according to claim 23, wherein the binder contains a photoinitiator for photochemical curing of the binder.

25. The method according to claim 23, wherein a thermoplastic, duromer, elastomer, or a mixture thereof is used as the binder.

26. The method according to claim 18, wherein the green part is built up in layers, the following steps being carried out for each green part layer:
applying a layer of the material composition to form a material layer,
location-selectively polymerizing the material layer to obtain a location-selectively polymerized green part layer.

27. A material composition for the additive, sinter-based production of at least one of metallic components and ceramic components, comprising:
an organic binder and particles of at least one of metal and ceramic;
wherein the particles are provided with at least one barrier layer enveloping them.

28. The material composition according to claim 27, wherein the at least one barrier layer consists of a metal oxide or a plastic.

29. The material composition according to claim 28, wherein the metal oxide is selected from the group consisting of silicon oxide, aluminum oxide, boron oxide, zirconium oxide, cerium oxide, iron oxide, titanium oxide, chromium oxide, tin oxide, molybdenum oxide, hydrated oxides thereof, hydroxides thereof, and mixtures thereof.

30. The material composition according to claim 28, wherein the plastic is selected from the group consisting of polyamides, polycarbonates, polyvinyl chloride, polyethylene terephthalate, and mixtures thereof.

31. The material composition according to claim 27, wherein the barrier layer has an average thickness of 1-300 nm.

32. The material composition according to claim 27, wherein the binder is a chemically or physically at least partially solidifiable material.

33. The material composition according to claim 32, wherein the binder is a thermoplastic, duromer, elastomer, or a mixture thereof.

34. The material composition according to claim 32, wherein the binder contains a photoinitiator for photochemical curing of the binder.
